(19) United States
(12) Patent Application Publication
(10) Pub. No.: US 2026/0246558 A1
(43) Pub. Date: Aug. 20, 2026

(54) SYSTEM AND METHOD FOR DETECTION OF CELLULAR SIGNAL JAMMING FOR SECURITY SYSTEMS

(71) Applicant: Digital Monitoring Products, Inc., Springfield, MO (US)

(72) Inventors: Quentin Easterling, Springfield, MO (US); Brian Arnberg, Springfield, MO (US); Samir Hammadi, Springfield, MO (US)

(73) Assignee: Digital Monitoring Products, Inc., Springfield, MO (US)

(21) Appl. No.: 19/538,320

(22) Filed: Feb. 12, 2026

Related U.S. Application Data
(60) Provisional application No. 63/758,768, filed on Feb. 14, 2025.

(51) Int. Cl. H04K 3/00

(52) U.S. Cl. CPC H04K 3/42; H04K 3/226

(57) ABSTRACT

Systems and devices for detecting cellular signal jamming are disclosed. A cellular jamming detection system includes an antenna configured to receive radio frequency (RF) energy and a plurality of RF measurement channels associated with different cellular frequency bands. The RF measurement channels generate RF energy measurements representative of RF energy present within their respective frequency bands. Processing circuitry evaluates the RF energy measurements relative to reference RF energy levels to identify elevated RF energy within individual frequency bands and determines that a cellular jamming event has occurred based on identification of elevated RF energy in a plurality of the frequency bands. Upon detection of the cellular jamming event, the system generates an output indicative of the detected jamming condition. The disclosed systems enable reliable detection of intentional cellular interference independent of cellular network connectivity and are suitable for use in security and monitoring applications.

### CROSS-REFERENCE TO RELATED APPLICATION

This application claims the benefit of U.S. Provisional Patent Application No. 63/758,768 filed Feb. 14, 2025, the disclosure of which is hereby incorporated by reference in its entirety.

### BACKGROUND

Wireless communication systems, such as cellular systems, are widely used in security, alarm monitoring, and other remote monitoring applications to transmit status information, alarm conditions, and other data to central monitoring stations or other networked devices. In many such applications, cellular communication serves as either a primary or backup communication path when wired communication is unavailable, impractical, or intentionally disabled.

In recent years, the use of handheld and portable radio frequency (RF) jamming devices to disrupt the communication paths of security systems has increased. Such jamming devices are typically capable of transmitting radio-frequency (RF) energy across one or more frequency bands at power levels sufficient to locally interfere with or disrupt normal wireless communications and to thus prevent transmission of important security and alarm events to remote or central monitoring stations. While the use of RF jammers is illegal in most jurisdictions, such jamming devices remain available and accessible and may be used to intentionally impair cellular communication in security and alarm monitoring installations.

Conventional security systems that rely on cellular communication may be unable to reliably detect the presence of a jamming condition. In many cases, a loss of cellular communication may be indistinguishable from other conditions-such as poor signal coverage, transient interference, network congestion, or temporary service outages. As a result, a security system may be rendered inoperable and/or unable to communicate with a monitoring station without providing a clear indication that intentional jamming has occurred.

While approaches to detecting wireless (or other) interference currently exist, such approaches often fail to detect jamming events that do not immediately result in complete communication loss, or may generate false indications due to normal fluctuations in network conditions. In addition, systems that rely solely on monitoring a single frequency band or a specific communication channel may be particularly vulnerable to broadband or multi-band jamming devices that simultaneously affect multiple cellular bands.

Furthermore, many existing detection systems are not designed to provide a dedicated, independent indication of a specific jamming event that can be acted upon by a security panel, monitoring system, or local notification device. In the absence of such an indication, an in-process or attempted jamming attack may go unnoticed, leaving the security system in a compromised state.

Thus, it can be seen that there remains a need in the art for improved systems and methods for detecting cellular signal jamming events in a reliable and timely manner.

### SUMMARY

Embodiments of the invention are defined by the claims below, not this summary. A high-level overview of various aspects of the invention is provided here to introduce certain concepts that are further described in the detailed description section below. This summary is not intended to identify key or essential features of the claimed subject matter, nor is it intended to be used in isolation to determine the scope of the claimed subject matter.

The present invention is directed to systems and devices for detecting cellular signal jamming. Cellular communication systems are commonly used in security, alarm, and property monitoring applications, thus intentional interference with cellular communication may impair the ability of such systems to transmit information, such as alarm notifications and alerts. The systems and methods disclosed herein detect jamming conditions by monitoring radio frequency (RF) energy across multiple cellular frequency bands and identifying RF interference patterns indicative of intentional jamming activity.

In exemplary embodiments, a cellular jamming detection system includes an antenna configured to receive RF energy from the surrounding environment and a plurality of RF measurement channels, each associated with a different cellular frequency band. The RF measurement channels generate RF energy measurements representative of the RF energy present within their respective frequency bands. Processing circuitry evaluates the RF energy measurements relative to reference RF energy levels established during normal operation to identify elevated RF energy within individual frequency bands.

Detection of a cellular jamming event is based on evaluation of RF energy conditions across a plurality of frequency bands. In exemplary embodiments, the system determines that a jamming event has occurred when elevated RF energy is identified in more than one frequency band, thereby reducing susceptibility to false indications caused by transient interference or band-limited RF conditions. The system may further evaluate RF energy measurements over time to distinguish sustained interference indicative of jamming from normal variations in ambient RF conditions.

Upon detection of a cellular jamming event, the system generates an output indicative of the detected condition. The output may be provided to a security panel, monitoring system, or other external device, thus enabling detection of jamming independent of the cellular communication path that may be impaired by the interference. In some embodiments, the system includes indicators and/or output switching circuitry to provide local and/or remote notification of the detected jamming condition.

### DESCRIPTION OF THE DRAWINGS

Illustrative embodiments of the invention are described in detail below with reference to the attached drawing figures, and wherein:

FIG. 1A is a block diagram of a system for detecting cellular signal jamming in accordance with an exemplary embodiment of the present invention.

FIG. 1B is a detailed block diagram view of an exemplary radio frequency (RF) block of FIG. 1A.

FIG. 2 is a flow diagram of a method for detecting cellular signal jamming using multi-band RF energy analysis in accordance with an exemplary embodiment of the present invention.

FIG. 3 is a timing diagram depicting RF energy measurement, averaging, and persistence for jamming detection in accordance with an exemplary embodiment of the present invention.

FIG. 4 is a system diagram depicting integration of a cellular jamming detection device with a security or monitoring system in accordance with an exemplary embodiment of the present invention.

FIG. 5 is a block diagram showing output signaling and tamper circuitry in accordance with an exemplary embodiment of the present invention.

### DETAILED DESCRIPTION

The subject matter of select embodiments of the invention is described with specificity herein to meet statutory requirements, however, the description itself is not intended to necessarily limit the scope of claims. Rather, the claimed subject matter may be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

As used herein, the term “jamming” refers to the presence of radio frequency (RF) energy at levels sufficient to impair or prevent normal and/or authorized wireless communication within one or more frequency bands. A “cellular jamming event” refers to a condition in which such RF energy interferes with cellular communication used by a communication device, security system, or monitoring system.

Embodiments of the invention as described herein are directed to systems and methods for detecting cellular signal jamming by monitoring RF energy across multiple cellular frequency bands and identifying sustained RF interference indicative of intentional jamming activity. The invention operates independently of the cellular network and cellular communication protocol itself and does not rely solely on loss of network connectivity to determine that a jamming condition exists.

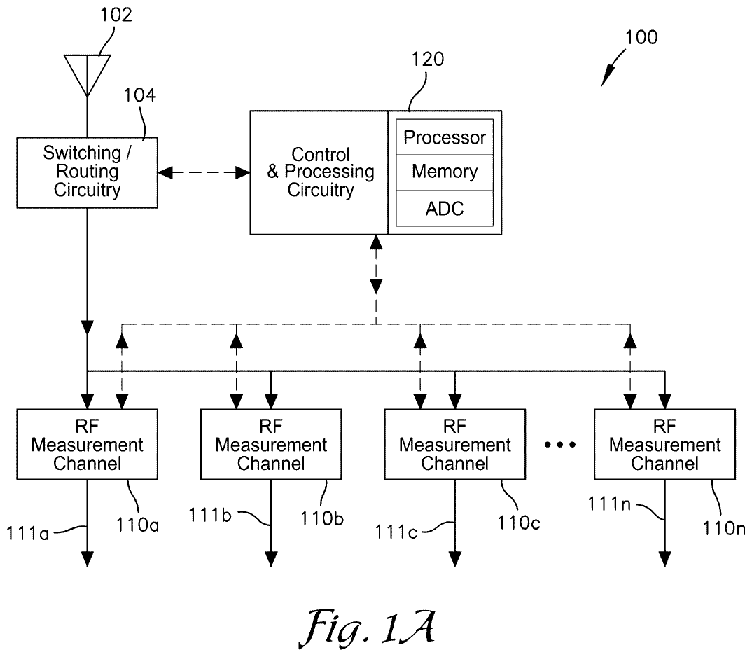

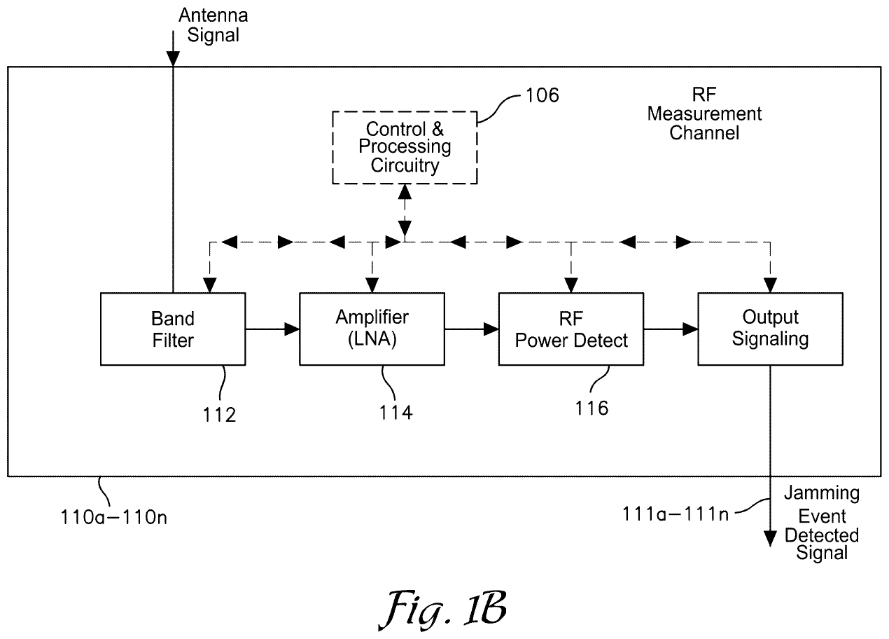

In exemplary embodiments, a jamming detection system includes RF measurement circuitry configured to receive RF energy from the surrounding environment, processing circuitry configured to analyze the received RF energy over time, and output circuitry configured to provide an indication when a cellular jamming event is detected. One illustrative embodiment of such a system is depicted in FIG. 1.

The jamming detection system is configured to monitor a plurality of cellular frequency bands concurrently, or in rapid succession. Rather than relying on instantaneous RF measurements, the jamming detection system evaluates RF energy levels relative to reference conditions established during normal operation of the security system. By analyzing both the magnitude and persistence over time of RF energy across multiple frequency bands, the system is able to distinguish intentional jamming from transient interference, background noise, or normal variations in RF signal conditions.

In one exemplary embodiment, RF energy is received by an antenna and directed to a plurality of RF measurement channels, with each channel corresponding to a different cellular frequency band of interest. Each channel independently conditions and measures the RF energy within its associated frequency band and provides a corresponding measurement signal to processing circuitry. While a specific RF implementation is illustrated in FIG. 1, it should be understood that the invention is not limited to any particular RF architecture, and that other filtering, amplification, or measurement techniques capable of providing band-specific RF energy measurements may be employed.

The processing circuitry, which may be implemented using a microcontroller, processor, logic and control circuitry, and other ancillary circuitry evaluates RF energy measurements from each channel over time. Reference RF energy levels may be established during system initialization or may be periodically updated during operation. During operation, contemporaneous RF energy measurements are compared to the baseline reference levels to determine whether the RF energy within a given channel exceeds a predetermined threshold for a sufficient duration so as to indicate a jamming condition.

The detection of a cellular jamming event is preferably based on an aggregated evaluation of multiple frequency bands. In exemplary embodiments, a jamming event may be declared when RF energy exceeding the reference level is detected in a predetermined number of monitored frequency bands, such as when all, or all but one, of the monitored bands exhibit sustained elevated RF energy. This multi-band evaluation reduces susceptibility to false indications resulting from localized interference or other anomalous conditions that affect only a single frequency band.

Upon detection of a cellular jamming event, the system provides an output indicating the detected condition. The output may be used to notify a security panel, monitoring system, or other external device that a jamming event has occurred, thus allowing remedial action to be taken independently of the cellular communication path that may be impaired by the jamming activity.

Turning first to FIG. 1A, a jamming detection system 100 in accordance with an exemplary embodiment of the present invention is depicted. When deployed in conjunction with a security system that uses cellular communication, RF energy from the environment encompassing and/or surrounding the area in which the security system is deployed is received by an antenna 102, with the antenna configured to receive signals across the cellular frequency bands of interest. The antenna 102 may be a broadband antenna suitable for receiving RF energy across multiple cellular bands, or in some embodiments the antenna may be selected or tuned to receive specific frequency ranges commonly used for cellular communication. The antenna 102 is preferably coupled to the jamming detection system 100 using a common RF input or other connector.

In exemplary embodiments, the received RF energy is directed from the antenna 102 to RF signal routing/switching circuitry 104. The signal routing circuitry 104 is configured to distribute the received RF signal to a plurality of RF measurement channels, 110a through 110n, either simultaneously or in a controlled sequence. Control of the routing circuitry 104 is provided by control and processing circuitry 120, to coordinate measurement timing and/or to manage power consumption. It should be understood that in some embodiments the antenna 102 may be coupled directly to each of multiple RF measurement channels 110a through 110n without requiring active switching.

Control and processing circuitry 120 preferably includes one or more processors, memory, and analog-digital-conversion (ADC) circuitry, with the processor operable to perform sequences of instructions stored in the memory to implement various functionality.

Each RF measurement channel, 110a through 110n, is associated with a specific cellular frequency band to be monitored by the system 100, with each measurement channel providing a “jam detected” signal 111a-111n upon detection of jamming of that frequency as will be explained in more detail below. As depicted in FIG. 1A, the control and processing circuitry is coupled to each of the RF measurement channels, and in a preferred embodiment, the switching/routing circuitry, control processing circuitry, and RF measurement channels are all co-located in a single enclosure for the system, and wired and configured such that each RF measurement channel may share the same control processing circuitry rather than necessarily each having its own separate processor, memory, and ADC circuitry.

Turning to the close-up view of FIG. 1B, each RF measurement channel 110a through 110n is nearly identical, varying only in minor changes to the circuitry and/or functionality implemented by the control and processing circuitry to tune each RF measurement channel to process RF signals within a specific frequency band.

As seen in FIG. 1B, each RF measurement channel includes RF conditioning circuitry configured to selectively pass RF energy within its associated frequency band while attenuating RF energy outside of that band. In the exemplary implementation as depicted in FIG. 1B, the RF conditioning circuitry includes a band filter 112 configured and operable to pass frequencies from the incoming signal captured by the antenna and routed either directly into the RF measurement channel or switched to the RF measurement channel by the switching/routing circuitry 104 of FIG. 1A.

The band filter 112 is operable to pass frequencies within a particular range and to attenuate frequencies outside of that range, and may be any type of band-pass filter, such as a surface acoustic wave (SAW) filter, tuned to the desired cellular band. The use of band-selective filtering 112 allows RF energy measurements from each RF measurement channel (110a through 110n) to be substantially independent of RF energy present in other frequency bands.

From the band filtering circuitry 112, RF energy within each channel 110a-110n is amplified by a low-noise amplifier (LNA) 114 or other similar amplification circuitry. The amplifier 114 increases the magnitude of the filtered RF signal to a level suitable for subsequent measurement while minimizing the introduction of additional noise. The amplified RF signal is then passed to RF power measurement circuitry 116.

RF power measurement circuitry 116 preferably includes a logarithmic detector configured to convert RF signal power, such as expressed in decibel-milliwatts (dBm), into a corresponding voltage or digital signal representative of the RF energy level present within the channel. The use of a logarithmic detector 116 allows a wide dynamic range of RF energy levels to be measured and allows comparison of RF energy measurements over time.

Each RF measurement channel 110a-110n communicates its RF energy measurement output to control and processing circuitry 120 as discussed above. As also discussed above, the processing circuitry 120 preferably includes analog-to-digital conversion (ADC) circuitry or comparable processing capability for sampling voltage outputs from the RF power detection circuitry 116. In alternative embodiments, the processing circuitry 120 may receive digital RF energy measurements directly from the low-noise amplifier 114.

While FIGS. 1A and 1B depict a particular RF measurement architecture employing band filters 112, amplification 114, and power detection 116, it should be understood that the invention is not limited to this specific configuration. Other RF measurement implementations capable of providing frequency-band specific RF energy measurements may be employed without departing from the scope of the invention, provided that the system 100 is capable of independently evaluating RF energy levels associated with multiple cellular frequency bands.

By providing independent RF energy measurements for a plurality of cellular frequency bands, the system 100 initially establishes baseline data that may be used to determine whether a cellular jamming event is occurring. The evaluation and analysis of the measurements over time to identify jamming conditions will be described in further detail below.

Rather than relying on instantaneous RF energy measurements, it should be understood that the system 100 is configured to evaluate RF energy levels over time relative to reference conditions established during normal operation to determine potential jamming events. This allows the system to distinguish intentional jamming from transient interference, short-duration noise spikes, or normal variations in ambient RF conditions.

In preferred exemplary embodiments, the processing circuitry 120 establishes a reference RF energy level, or baseline level, for each RF measurement channel 110a-110n. The baseline RF energy level for a given channel may be determined during system initialization by sampling RF energy measurements over a predetermined period of time and computing an average or representative baseline value. In other embodiments, baseline RF energy levels may be periodically updated during operation to account for gradual changes in the RF environment.

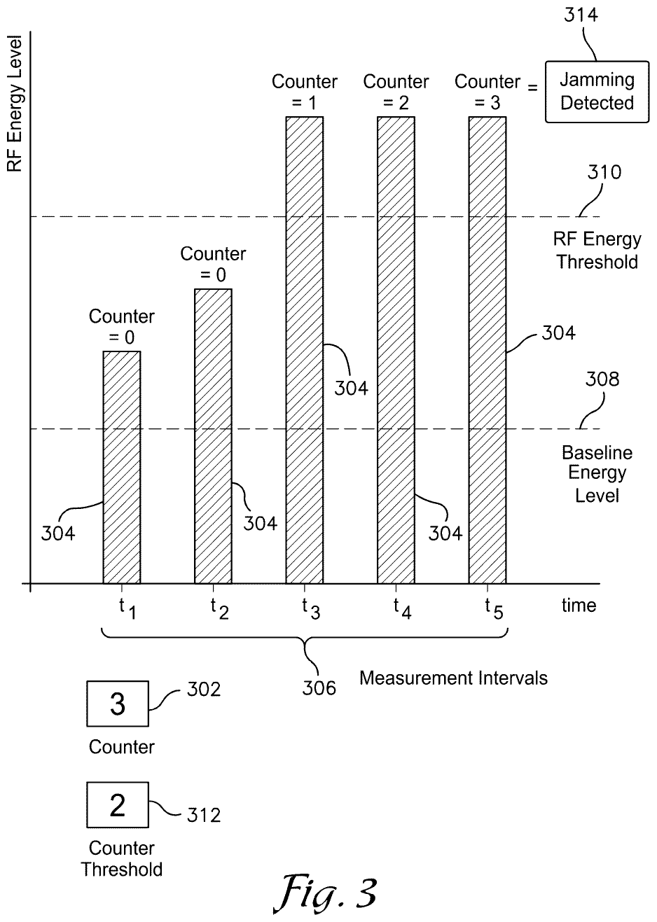

In one embodiment, current RF energy measurements for each channel 110a-110n are obtained by sampling the output of the RF power detection circuitry 116 using the ADC of the control and processing circuitry 120. As seen in FIG. 3 and as will be discussed in more detail below, RF energy measurements may be averaged over a defined measurement time interval to reduce sensitivity to any instantaneous fluctuations. In one exemplary embodiment, RF energy measurements are averaged over successive time windows, with each window having a duration selected to balance responsiveness with noise immunity.

For each RF measurement channel 110a-110n, the processing circuitry 120 compares the averaged RF energy measurement to the corresponding baseline RF energy level. If the averaged RF energy exceeds the baseline level by at least a predetermined threshold amount, the system identifies the condition as a potential interference event for that channel. In various embodiments, the threshold may be expressed as a relative increase over the baseline, such as a percentage deviation or a specified decibel difference, or may be selected based on the characteristics of the RF measurement circuitry and the expected RF environment.

To further reduce false detections, the system 100 evaluates whether any detected elevated RF energy persists over a sufficient duration of time, which may indicate intentional jamming. In exemplary embodiments, the processing circuitry 120 preferably maintains a counter (as seen in FIG. 3 and discussed in more detail below) for each RF measurement channel 110a-110n. The corresponding counter for each channel is incremented when the RF energy measurement for that channel exceeds the threshold, and is reset when the RF energy measurement falls below the threshold. When the counter for a particular channel reaches a predetermined count value, corresponding to a sustained elevated RF energy over multiple measurement intervals, that channel is identified as exhibiting a jamming condition.

The processing circuitry 120 evaluates the “jamming event detected” signal 111a-111n of each of the plurality of RF measurement channels 110a-110n to determine whether a cellular jamming event has occurred. In a preferred embodiment, the system applies a voting (or quorum) based decision rule in which a jamming event is declared when a predetermined number of channels are simultaneously designated as jammed. For example, in one implementation, the system may declare a jamming event when all, or all but one, of the monitored channels exhibit sustained elevated RF energy. This may be referred to herein as an “N-1” evaluation, where N represents the total number of channels being monitored.

In preferred embodiments, the quorum requirement may be selected based on the number of frequency bands monitored and the desired balance between sensitivity and false indication avoidance. Requiring agreement across multiple channels ensures that localized interference, band-specific noise, or anomalous behavior affecting only a single frequency band does not result in a false jamming event indication.

Once the processing circuitry 120 determines that the multi-channel evaluation and/or voting criteria are satisfied, the system 100 identifies the condition as a cellular jamming event and generates an output indicating the detected jamming condition. The output preferably provides a mechanism by which the detected jamming event can be communicated as an event or signal to a security system, security panel, monitoring system, or other external device, independent of the cellular communication path that may be impaired by the jamming activity. The jamming detection logic and voting as just described may be implemented in software, firmware, hardware, or any combination thereof within the processing circuitry 120.

System 100 may be powered by an external power source and, in some embodiments, may include backup power capability to maintain operation during power interruptions. Output signaling may be configured such that loss of power results in a defined output state, allowing external systems to detect loss of the jamming detection device or its power source.

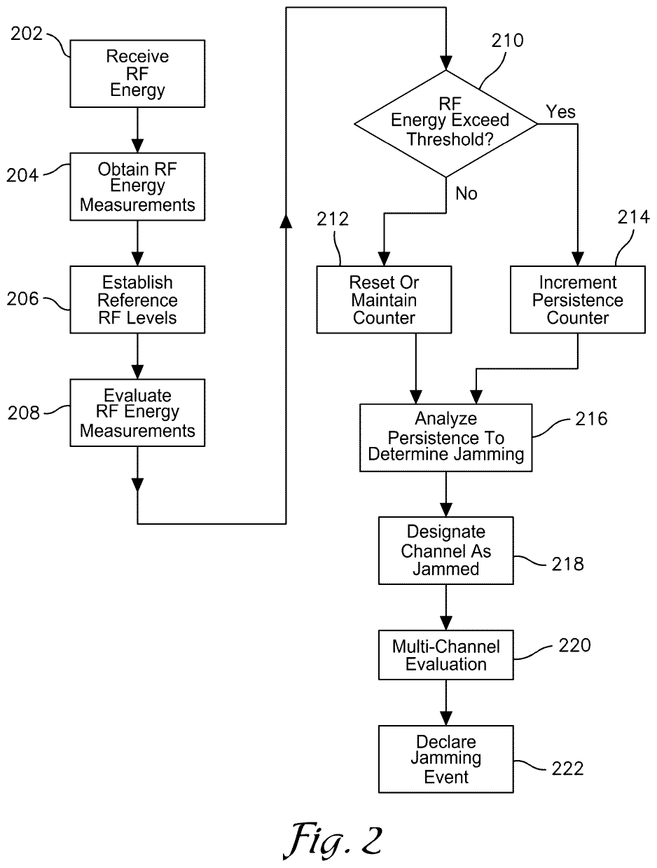

With the general configuration and operation of the system as set forth above, looking now to FIG. 2, a method 200 for detecting cellular signal jamming in accordance with an exemplary embodiment of the present invention will now be described. Method 200 may be implemented by the cellular jamming detection system 100 as described above, and in particular may be executed by the processing circuitry 120 of the system in cooperation with the individual RF measurement channels 110a-110n.

At block 202, RF energy is received from the surrounding environment. As depicted in FIGS. 1A and 1B, RF energy may be received via the antenna 102 and distributed to the plurality of RF measurement channels 110a-110n, each corresponding to a different cellular frequency band to be monitored.

At block 204, RF energy measurements are obtained for each of the plurality of RF measurement channels. With reference to FIGS. 1A and 1B, RF energy measurements are generated by RF power detection circuitry 116 and sampled by the processing circuitry 120, in some embodiments via analog-to-digital conversion circuitry.

At block 206, reference RF energy levels are established for each RF measurement channel. In preferred embodiments, the reference RF energy levels may be determined during system initialization by averaging RF energy measurements over a predetermined period of time, in some embodiments the reference RF energy measurements may be updated periodically during operation to account for changes in ambient RF conditions.

At block 208, current RF energy measurements for each RF measurement channel are evaluated relative to the corresponding reference RF energy levels. In exemplary embodiments, RF energy measurements are averaged over defined measurement intervals to reduce sensitivity to instantaneous fluctuations.

At decision block 210, the method determines whether the RF energy measurement for a given channel exceeds the reference RF energy level by at least a predetermined threshold. If the threshold is not exceeded, the method proceeds to block 212, where any persistence counter associated with that channel is reset or maintained in a non-jammed condition.

If, at block 210, the RF energy measurement for the channel exceeds the predetermined threshold, the method proceeds to block 214, where a persistence counter associated with the specific channel is incremented. The persistence counter for each channel thus tracks whether elevated RF energy persists across multiple measurement intervals for that channel (as will be discussed in more detail with respect to FIG. 3, below).

At block 216, the method determines whether the persistence counter has reached a predetermined count value corresponding to sustained elevated RF energy. If the count value has not been reached, the method continues monitoring RF energy measurements for that channel. If the count value is reached, the method proceeds to block 218, where the channel is designated as being in a jammed condition.

At block 220, the method evaluates the jammed signals 111a-111n of the plurality of RF measurement channels collectively. In exemplary embodiments, a cellular jamming event is identified when a predetermined number of channels are simultaneously designated as jammed. For example, a jamming event may be declared when all, or all but one (i.e., “N-1”) of the monitored channels exhibit sustained elevated RF energy.

At block 222, upon determination that the multi-channel evaluation criteria are satisfied, the method declares a cellular jamming event and generates a corresponding jamming event signal. The jamming event signal may be used to activate output indicators, output switching circuitry, or to notify an external system such as alarm panel, security system, etc. of the detected jamming condition, as described above.

If the multi-channel evaluation criteria are not satisfied at block 220, the method returns to the beginning for continued/continuous RF monitoring and evaluation.

The method 200 may be executed continuously or periodically during system operation, thus allowing the system to detect cellular jamming events in real time, or near real time. By requiring sustained RF interference across multiple frequency bands before declaring a jamming event, the method reliably detects intentional jamming while minimizing false indications caused by transient or band-limited RF conditions.

While FIG. 2 illustrates one exemplary method for evaluating RF energy measurements over time, it should be understood that the specific sequence of operations, timing parameters, and threshold values may be varied without departing from the scope of the invention. Furthermore, it should be understood that the invention is not limited to any particular aggregation logic, and that other multi-channel evaluation techniques may be employed, provided that the system evaluates RF interference conditions across a plurality of frequency bands collectively rather than independently. Finally, the method 200 is depicted herein as a series of discrete operations, however, it should be understood that the order of operations may vary, that certain operations may be combined or omitted, and that additional operations may be included without departing from the scope of the invention.

Turning to FIG. 3, the measurement and evaluation of RF energy is shown for a single RF measurement channel (i.e., 110a-110n), as described above. The figure depicts how RF energy measurements are evaluated over time to determine sustained interference indicative of jamming.

As shown in FIG. 3, successive RF energy measurements 304 are obtained during successive measurement intervals 306, where the measurement intervals may correspond to averaging windows or sampling periods used by the processing circuitry 120 of the system 100 of FIGS. 1A and 1B. Each RF energy measurement 304 represents an averaged or representative RF energy level for the corresponding interval 306.

A reference RF energy level, or baseline 308, is established for the channel during normal operation, as described above. A threshold 310 is defined relative to the baseline 308, such that RF energy measurements exceeding the threshold indicate abnormal RF activity for that channel.

As described above with respect to FIG. 2, when an RF energy measurement 304 exceeds the RF energy threshold 310, a persistence counter 302 associated with the channel is incremented—e.g., counters 302a-302n corresponding to channels 110a-110n, respectively. For each channel, when an RF energy measurement falls below the threshold 310, the persistence counter 302 for that channel may be reset or decremented, depending on the specific desired implementation of persistence—for example, in some instances every occurrence of an energy level above the threshold may be accumulated and counted, in other instances once an energy level drops below the threshold level the counter is reset to zero. The persistence counter 302 thus represents the number of consecutive or cumulative measurement intervals in which elevated RF energy has been detected.

As illustrated in FIG. 3, when the persistence counter 302 reaches a predetermined count value 312, the channel is designated as being jammed 314. RF energy measurements that exceed the threshold 310 for fewer than the predetermined number of intervals do not result in a jammed condition, thereby preventing transient RF disturbances from triggering a jamming indication. And, as discussed above, any subsequent energy measurement below the threshold may either be ignored (e.g., the counter is not incremented) or may reset the count (e.g., the counter is reset to zero). Thus, the aggressiveness of the jamming detection may be tailored by adjusting the counter threshold 312 as well as by adjusting how subsequent energy measurements below the threshold are handled—e.g., either by not incrementing the counter or by resetting the counter to zero.

It should be understood that FIG. 3 is illustrative only, and that the specific durations of the measurement intervals 306, the threshold level 310, and the predetermined counter threshold value 312 may be selected and adjusted based on system requirements and environmental conditions.

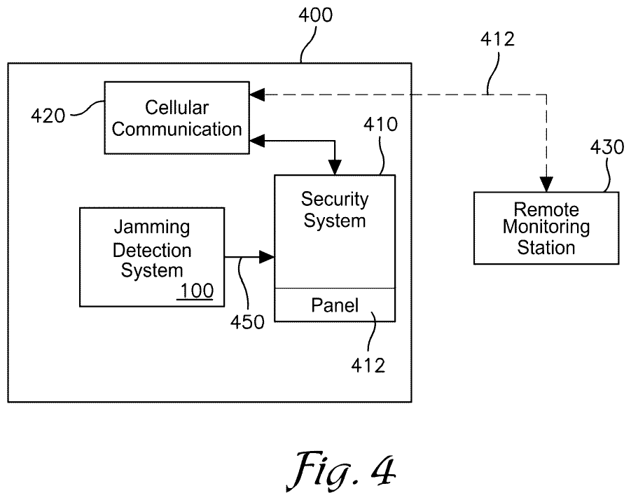

Looking to FIG. 4, an exemplary embodiment of a jamming detection system as in FIGS. 1A and 1B above is depicted, deployed in an environment having a security system in communication with a central monitoring station via a cellular communication network.

As shown in FIG. 4, the jamming detection system 100 is installed in an environment 400 (such as a room, building, or area) being monitored by a security system 410. The security system 410 preferably includes a control panel 412 which provides a user interface, and input/output circuitry to allow connecting motion sensors, cameras, switches, lights, alarms, and the like to the security system. The security system 410 is in communication with a cellular communication device 420 which allows the security system 410 to communicate with a remote central monitoring station 430 via cellular telephone radio signals 412. In use, the jamming detection system 100 is installed in proximity to the cellular communication device 420, with the “jamming detected” signal from the jamming detection system connected as a switch input to the security system.

With the jamming detection system 100 thus connected to the security system 410, the security system will see and respond to the “jamming detected” signal just as it would to any other connected and monitored switch. Thus, upon detection of a cellular jamming condition the security system may respond by generating an alarm, notification, or event record to alert users that a jamming condition has been detected.

In exemplary embodiments, the processing circuitry 120 asserts a jamming event signal 402 when the multi-channel evaluation criteria are satisfied. The jamming event signal 402 may be used to activate one or more output devices or interfaces configured to provide a visible, audible, electrical, or logical indication of the detected jamming condition.

The jamming detection system 100 is preferably positioned such that it can reliably monitor RF energy present in the vicinity of the cellular communication device 420, thus allowing the system 100 to detect RF interference conditions that may impair cellular communication. In some embodiments, the jamming detection system 100 may be housed within the same enclosure as the cellular communicator 410, within the enclosure of the security or monitoring system 420, or within a separate enclosure located nearby.

The output signaling circuitry of the jamming detection system 100 is preferably coupled to the security system 410 via a wired connection 450. The wired connection 450 may be connected to an input, zone, or notification circuit of the security or monitoring system 410, allowing the security system to receive a jamming event indication independent of the cellular communication path.

It should be understood that the security system 410 communicates with the remote monitoring stations 430 via the cellular communication device 420 under normal operating conditions. When cellular jamming occurs, however, this communication path may be degraded or unavailable, but the jamming detection system 100 continues to provide a local indication of the jamming condition to the security or monitoring system 410.

FIG. 4 is illustrative only, and other deployment configurations may be employed. For example, the jamming detection system 100 may be integrated directly into a security system control panel, may report jamming events to other types of monitoring equipment, or may provide local notification without connection to a remote monitoring station.

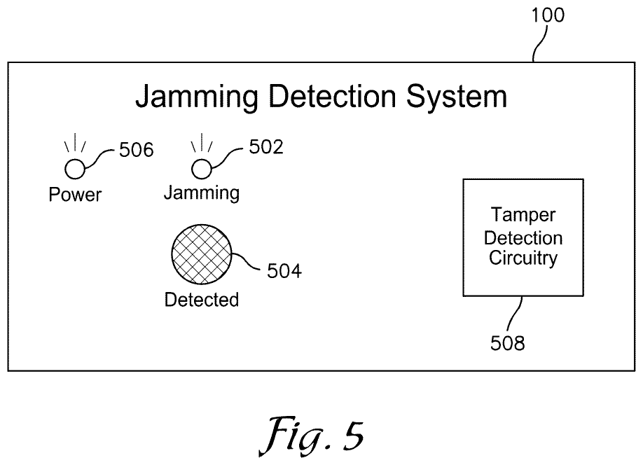

Turning to FIG. 5, in some embodiments the jamming detection system 100 may itself include one or more visual 502 and/or audible indicators 504, such as light-emitting diodes (LEDs), buzzers, etc. configured to provide a local visual and/or audible indication of a detected jamming event or other system operational parameters. Other indicators, such as a power indicator 506, may indicate that the system is powered-on and operational. The indicators are preferably driven directly by the processing circuitry 120 or via intermediate driver circuitry.

In further embodiments, the jamming detection system 100 may further include tamper detection circuitry 508 configured to detect physical tampering with the device, such as opening of an enclosure or removal from a mounting surface. The tamper detection circuitry 508 may include one or more tamper sensors, such as switches or contacts, and may generate a tamper signal when a tamper condition is detected. The tamper detection circuitry is preferably in communication with the control and processing circuity 120 of the tamper detection system 100.

While the jamming detection system of the present invention has been described herein with respect to various exemplary embodiments, variations of those embodiments are within the scope of the present invention. In some alternative embodiments, the cellular jamming detection system 100 may be implemented as a compact electronic module configured for installation within, or in proximity to, a security system control panel, cellular communicator, or other monitoring equipment. The physical dimensions and form factor of the system 100 may be selected to fit within an existing enclosure or housing, and may share mechanical or electrical interfaces with other system components.

In some embodiments, the system 100 may be powered by an external power source, such as a direct current (DC) power supply provided by a security panel or monitoring. In other embodiments, the system 100 may include backup power capability 606, such as a battery or energy storage device, to maintain operation during loss of primary power.

Furthermore, while the exemplary embodiments have been described with reference to RF measurement channels 110a-110n employing band-selective filtering, amplification, and RF power detection, the invention is not limited to any particular RF measurement implementation. Other techniques capable of providing frequency-band-specific RF energy measurements may be employed. For example, alternative embodiments may use integrated RF receiver modules, different filtering technologies, or other RF sensing architectures, provided that the system is capable of independently evaluating RF energy associated with multiple cellular frequency bands and applying persistence-based and multi-channel evaluation logic as described herein.

It should be understood that the various features and embodiments described throughout this disclosure may be combined or omitted as appropriate for a particular application. The described systems and methods may be executed continuously, periodically, or in response to defined triggers, and may be adapted to different cellular technologies or frequency band allocations without departing from the scope of the invention.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Certain features and sub-combinations are of utility and may be employed without reference to other features and sub-combinations and are contemplated within the scope of the claims.

What is claimed is:

1. A cellular jamming detection system, comprising:
an antenna configured to receive radio frequency (RF) energy from an environment;
a plurality of RF measurement channels, each RF measurement channel associated with a different cellular frequency band and configured to generate an RF energy measurement corresponding to RF energy present in the associated cellular frequency band;
processing circuitry operatively coupled to the plurality of RF measurement channels and configured to:
establish a reference RF energy level for each of the plurality of RF measurement channels;
obtain RF energy measurements from each of the plurality of RF measurement channels;
evaluate RF energy measurements relative to the corresponding reference RF energy levels to identify elevated RF energy within individual RF measurement channels;
determine that a cellular jamming event has occurred based on identification of elevated RF energy in a plurality of the RF measurement channels; and
output circuitry configured to generate a jamming indication in response to determination of the cellular jamming event.

2. The cellular jamming detection system of claim 1, wherein the processing circuitry is further configured to establish the reference RF energy level for each RF measurement channel by averaging RF energy measurements obtained during a reference period.

3. The cellular jamming detection system of claim 1, wherein the processing circuitry is further configured to obtain RF energy measurements by averaging RF energy measurements over successive measurement intervals.

4. The cellular jamming detection system of claim 1, wherein the processing circuitry is further configured to identify elevated RF energy within an RF measurement channel when the RF energy measurements exceed the corresponding reference RF energy level by at least a threshold amount.

5. The cellular jamming detection system of claim 1, wherein the processing circuitry is further configured to determine that elevated RF energy persists within an RF measurement channel based on RF energy measurements obtained over multiple measurement intervals.

6. The cellular jamming detection system of claim 1, wherein the processing circuitry is further configured to determine that the cellular jamming event has occurred when elevated RF energy is identified in the plurality of RF measurement channels.

7. The cellular jamming detection system of claim 1, wherein the processing circuitry comprises a microcontroller configured to execute instructions for evaluating RF energy measurements and generating the jamming indication.

8. A cellular jamming detection device, comprising:
RF receiving circuitry configured to receive RF energy across a plurality of cellular frequency bands;
a plurality of RF signal conditioning circuits, each RF signal conditioning circuit corresponding to a different cellular frequency band and configured to produce a band-specific RF energy signal;
a processor coupled to the plurality of RF signal conditioning circuits and configured to:
establish baseline RF energy levels for the plurality of cellular frequency bands;
compare band-specific RF energy signals to the corresponding baseline RF energy levels;
determine whether elevated RF energy persists in each cellular frequency band for longer than a predetermined duration; and
declare a cellular jamming condition based on concurrent persistent elevated RF energy in more than one cellular frequency band; and
an output interface operable to provide a signal indicative of the declared cellular jamming condition.

9. The cellular jamming detection device of claim 8, wherein each RF signal conditioning circuit comprises a band-selective filter configured to pass RF energy within the corresponding cellular frequency band.

10. The cellular jamming detection device of claim 9, wherein the band-selective filter comprises a surface acoustic wave (SAW) filter.

11. The cellular jamming detection device of claim 8, wherein each RF signal conditioning circuit further comprises a low-noise amplifier coupled to the band-selective filter.

12. The cellular jamming detection device of claim 8, wherein each RF signal conditioning circuit further comprises an RF power detector configured to generate a signal representative of RF signal power.

13. The cellular jamming detection device of claim 12, wherein the RF power detector comprises a logarithmic detector.

14. The cellular jamming detection device of claim 8, wherein the output interface comprises a relay configured to change state in response to declaration of the cellular jamming condition.

15. The cellular jamming detection device of claim 8, further comprising a visual indicator configured to provide a visible indication of the declared cellular jamming condition.

16. A method for detecting cellular signal jamming, comprising:
receiving radio frequency (RF) energy from an environment;
obtaining RF energy measurements for each of a plurality of RF measurement channels corresponding to different cellular frequency bands;
establishing reference RF energy levels for the plurality of RF measurement channels;
comparing the RF energy measurements to the corresponding reference RF energy levels;
identifying elevated RF energy within individual RF measurement channels based on the comparing;
determining whether the elevated RF energy persists over multiple measurement intervals for each RF measurement channel;
evaluating RF energy conditions across the plurality of RF measurement channels collectively; and
declaring a cellular jamming event when elevated RF energy is detected in a predetermined number of the RF measurement channels.

17. The method of claim 16, wherein declaring the cellular jamming event comprises declaring the cellular jamming event when elevated RF energy is detected in the plurality of RF measurement channels.

18. The method of claim 16, wherein determining whether the elevated RF energy persists comprises maintaining a persistence counter for each RF measurement channel and incrementing the persistence counter when the RF energy measurements exceed a threshold.
